(19) United States
(12) Patent Application Publication
(10) Pub. No.: US 2004/0249669 A1
(43) Pub. Date: Dec. 9, 2004

(54) System and methods for generating physician profiles concerning prescription therapy practices with self-adaptive predictive model

(76) Inventors: Richard D. Pollack, Newtown, PA (US); Brian Wynne, Paoli, PA (US)

Correspondence Address: BAKER & BOTTS, 30 ROCKEFELLER PLAZA, NEW YORK, NY, 10112

(21) Appl. No.: 10/494,841

(22) PCT Filed: Nov. 14, 2001
(86) PCT No.: PCT/US01/43900

(51) Int. Cl. G06F 17/60; G06F 17/18; G06F 15/00; G06F 101/14

(52) U.S. Cl. 705/2; 702/181

(57) ABSTRACT

The invention relates to systems and methods for analyzing prescription claim histories for physicians, and creating profiles of the prescription therapies of such physicians.

### BACKGROUND OF THE INVENTION

1. Field of the Invention

The invention relates to systems and methods for analyzing prescription claim histories for physicians, and creating profiles of the prescription therapies of such physicians.

2. Related Art

Pharmaceutical sales representatives typically determine a territory call plan based on information about physicians in their respective coverage areas, and the range of pharmaceutical products that such physicians typically prescribe. This information may include the specialty of the physician, the physician's response to promotional efforts, the physician's ranking in the pharmaceutical product's market share, the physician's ranking in total market volume, and the physician's ranking in the pharmaceutical product's prescription volume. Based on observed patterns with respect to this information, further qualities about physicians have been successfully modeled such as “new product early adopter,” which refers to a physician who tends to prescribe a new product soon after it becomes available, or “brand loyalist,” which refers to a physician who continues to prescribe a specific branded drug, even in the face of competitive drug availability.

While the above information is derived from prescriptions written by the physicians, the information does not provide insight into either physicians' treatment practices over a given period of time, or such practices as applied to different patient types. Such targeting would require a more detailed understanding of a physician's treatment practices within his patient population, e.g., through the formation of a database of prescription activity for each physician where de-identified patients can be tracked to understand how a physician prescribes in a particular therapeutic area.

With the introduction of the new longitudinal prescription database (“LRx”), several new categories of prescriptions were developed: New Therapy Starts, Therapy Switches, Titration Increases, Titration Decreases, Add-on Therapies, and Continued Therapies, and others. Developing these categories was described in greater detail in commonly-assigned application Ser. No. 09/941,496 entitled “SYSTEM AND METHODS FOR GENERATING PHYSICIANS PROFILES CONCERNING PRESCRIPTION THERAPY PRACTICES”, filed Aug. 29, 2001, which is incorporated by reference in its entirety herein.

With these new categories of prescription data comes significantly improved capability to identify how a physician is prescribing in a certain market. Counts of each category are available at the individual product level and the market level, and market share can be calculated within each category. In addition, comparison between the different categories also provides insight into prescribing behavior. Compounded with the ability to track changes in each of these variables over time, many new continuous variables may be calculated from the above new categories of prescription data.

For example, a continuous variable, such as New Therapy Start share or Continued Therapy share, may be used to assess the degree of relationship to another variable, commonly referred to as the outcome or dependent variable. In observing physicians' prescription therapy practices, the dependent variable may be the probability of the occurrence of an event relevant to the prescription therapy practices of a physician, e.g., a change in market volume of a particular prescription product. An important feature of this statistical analysis is the predictive effect of the variables, i.e., the extent to which one variable influences the outcome of another variable, such as how a change in New Therapy Start share affects the market share of a product.

These continuous variables may be used to predict physicians' prescribing behavior using, for example, logistic regression models, which are known in the art. A problem may arise in the analysis of these continuous variables, however. Often the samples of LRx data are small, and distribution of the data may be erratic or skewed, which reduces the usefulness of such data. Moreover, to be useful, the predictive effect of a continuous variable used in a logistic regression model should be linear. Predictive accuracy may be compromised if the continuous variable does not have a stable linear relationship with the outcome, and many of the continuous variables described above do not exhibit such a linear relationship with the dependent variable. It has been demonstrated that continuous variables which do not have a stable linear relationship with the dependent variable can be converted to categorical variables having a plurality of categories or “levels” in order to improve their predictive value. However, the distribution of data for a continuous variable may vary significantly from one variable to another, which complicates the process of selecting an optimum number of levels, and performing the conversion to categorical data.

Accordingly, there exists a need in the art for a technique which can analyze the available prescription data, including the ability to convert the continuous variable data into useful categorical variable data which is adaptive to different data distributions.

### SUMMARY OF THE INVENTION

An object of the present invention is to provide a technique for analyzing the prescription practices of multiple physicians over a given period of time.

Another object of the present invention is to provide prescription activity analysis tools which can assist pharmaceutical sales representatives in understanding the prescription practices of physicians.

A further object of the present invention is to provide a technique for estimating the probability of the occurrence of certain events relevant to the prescribing practices of the physicians.

A still further object of the present invention is to provide a technique for converting continuous variables into categorical variables for use in a predictive model of physicians' prescribing behavior.

Yet another object of the present invention is provide a technique for optimizing the number of categorical variable levels to ensure the highest degree of predictive accuracy.

These and other objects of the invention, which will become apparent with reference to the disclosure herein, are accomplished by a system and method for generating a physician profile concerning the prescription therapies for de-identified patients issued by one or more physicians in a particular therapeutic area of interest.

Data is received by the system for analysis, which includes one or more continuous variables corresponding to prescriptions issued to at least one de-identified patient by at least one physician. The continuous variable is converted to a categorical variable having a number of levels. This conversion is performed for each one of a predetermined range of levels. The degree of statistical relationship is measured for the categorical variable with the dependent variable, i.e., the probability of the occurrence of an event relevant to the prescription prescribing practices of the physician in the therapeutic area of interest. This step of measuring is performed for each level of the predetermined range of levels of the categorical variable. A later stage in the process is to identify one of the number of levels of the predetermined range of levels that has the greatest statistically significant relationship with the occurrence of the event relevant to the prescription therapy practices of the physician.

The steps of converting the continuous variable to a categorical variable, measuring the degree of relationship of the categorical variable with the dependent variable, and identifying one of the predetermined number of levels having the greatest statistically significant relationship with the dependent variable are repeated for each one of the continuous variables. The process may also include discarding a categorical variable that is not statistically significant at any number of levels. A later step is estimating the probability of the occurrence of the event relevant to the prescription therapy practices of the physician by running a predictive model using the categorical variables and the number of levels as determined above.

In one exemplary arrangement, the predetermined range of levels is between two levels and five levels. The process of converting each continuous variable to a categorical variable may include using a cumulative percentage distribution function.

Advantageously, the step of measuring the degree of statistical relationship of the categorical variable with the probability of the occurrence of the event may include running a logistic regression model, and calculating a p-value corresponding to the categorical variable and the respective number of levels. The step of identifying the number of levels of the categorical variable having the greatest statistical significance comprises determining the respective number of levels of the categorical variable having the lowest associated p-value.

In accordance with the invention, the objects as described above have been met, and the need in the art for a technique which can analyze the long term prescription practices of a group of physicians, including the ability to convert continuous variable data to categorical variable data having an optimum number of levels, has been satisfied. Moreover, the predictive value of each level of categorical variable can be measured separately, resulting in far more intuitive and understandable explanation of the model's results. Further features of the invention, its nature and various advantages will be more apparent from the accompanying drawings and the following detailed description of illustrative embodiments.

### BRIEF DESCRIPTION OF THE DRAWINGS

FIG. 1 is a block diagram of an exemplary system in accordance with the invention.

FIG. 2 is a flowchart illustrating a portion of an exemplary procedure in accordance with the invention.

FIG. 3 is a flowchart illustrating a further portion of the procedure in accordance with the invention.

### DETAILED DESCRIPTION OF THE EXEMPLARY EMBODIMENTS

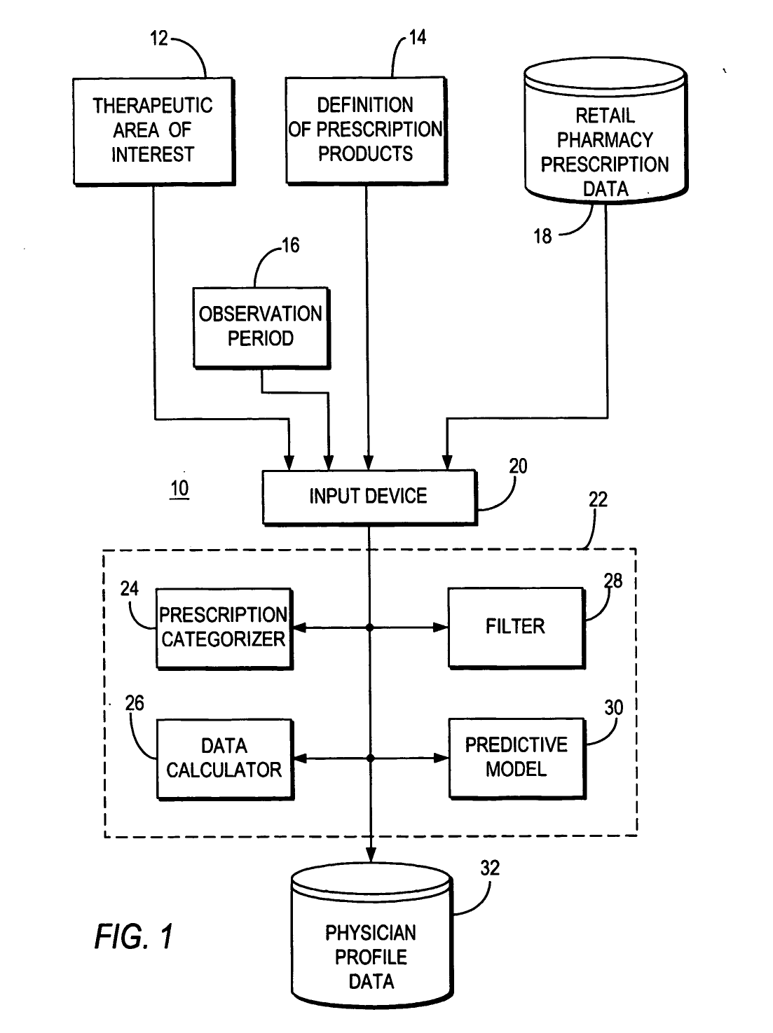

Referring now to FIG. 1, an illustrative embodiment of a system for processing prescription data is depicted and generally referred to as system 10. The system 10 may utilize several sources of information for processing. The user supplies information on a particular therapeutic area or market of interest 12, such as an anti-depressant therapy or blood pressure control therapy. The user may also supply information on certain prescription products which are to be included in the study 14. Time period information 16, i.e., an “observation period” may be selected by the user to specify the period of time in which to monitor the dispensing of prescriptions. Information on the specific prescriptions is included in prescription data, i.e., Retail Pharmacy Prescription data 18, which includes historical de-identified patient prescription data and is typically stored on a mass storage device, such as a disk drive or a tape. This input information in received by the system at the input device 20, such as, for example, a keyboard, mouse, disk drive, and the like.

The system 10 uses longitudinal prescription data from retail pharmacies, Retail Pharmacy Prescription data stored on a mass storage device 18, which supplies information such as the prescribing physician, the name of the prescription product dispensed, the dosage, refill information, i.e., an indication of whether or not a refill is authorized, the day supply, i.e., the number of days until the patient will need a refill, and the date dispensed. Retail Pharmacy Prescription data 18 groups the above information for one patient under a “de-identified” patient identification number. The de-identified patient identification number is an identifier that replaces a patient's name and protects patient confidentiality since it provides no personal information about the patient. This information allows the system to track prescription therapy over time for one specific, although unknown, patient. Thus whenever a “patient” or “patient data” is described herein, it is understood that the patient's identity and personal information are excluded (i.e., the patient is “de-identified”) in order to maintain confidentiality of patient records. The de-identified patient identification may also include the age and gender of the de-identified patient.

While the disclosure herein is described with use of Retail Pharmacy Prescription data, other data structures could readily be employed, such as Pharmacy Benefit Manager (PBM) prescription claims data, mail order prescription data, or a combination of data sources.

Several processing routines are executed by the CPU 22 of the system 10 (as indicated by the dashed line). A prescription categorizer 24, data calculator 26, filter 28, and predictive model 30 perform a series of data processing operations by the central processing unit of a computer, executing software programs in languages such as COBOL, which are stored in dynamic computer memory, such as RAM (not shown). Due to the intensive data processing that is performed in accordance with the invention, the computer is preferably a mainframe computer, such as an IBM 9672 mainframe computer. A software package, such as SAS™ or SPSS™ may be installed on the computer to perform the statistical calculations. These software packages are used for processing the prescription data and developing the predictive model, as will be described below. Other equivalent software packages may also be used. The input data is received by the prescription categorizer 24 which first considers whether each de-identified patient is “track-able” to be included into the prescription categorization process. Once track-ability is confirmed, then the prescription categorizer 24 compares the dosage and prescription product for a particular prescription for a each de-identified patient with the dosage and prescription product of another prescription for that de-identified patient identification number and categorizes the particular prescription based on a change in the dosage or the prescribed medication between the particular prescription and the other prescription. Each prescription may be categorized by the system into the following exemplary categories: (1) New Therapy Start, (2) Therapy Switch, (3) Add-on Therapy (concomitant), (4) Titration Decrease, (5) Titration Increase, and (6) Continued Therapy. Those skilled in the art will understand that other categories could be added. (The method of categorizing prescriptions as New Therapy Start, Therapy Switch, Add-on Therapy, Titration Decrease, Titration Increase, Continued Therapy, etc., is described in Tolle et al. U.S. patent application Ser. No. 09/941,496 entitled “SYSTEM AND METHODS FOR GENERATING PHYSICIANS PROFILES CONCERNING PRESCRIPTION THERAPY PRACTICES,” filed Aug. 29, 2001, which was incorporated by reference in its entirety above.) The categorized prescription data provides useful information in observing physicians' prescribing behavior.

A number of continuous variables can be calculated by routines such as those performed by data calculator 26, which selectively obtains totals of the categories described above to obtain count data. The data calculator 26 may also calculate new variables that are functions of previously mentioned variables. such as ratios or observed data trends over time. The prescription data as calculated by the data calculator 26 is continuous. Continuous variables, as used herein and generally understood in the art, are variables that are quantitative in nature, and can take on any value in a range. Thus, when continuous variables are plotted, the distances between points are meaningful. Examples of continuous variables that may be calculated by data calculator 26 are (a) the percentage share of categories, e.g., the percentage share of New Therapy starts for a physician, the percentage share of Continued Therapy for a prescription product; (b) count data, e.g., the total number of New Therapy starts for a product, the difference between the New Therapy start share and the Continued Therapy share; and (c) trend data, e.g., the change in New Therapy Start share over a period of time.

Exemplary routines run by the data calculator 26 are discussed herein. For example, the prescribing practices of a physician for a particular market of interest which includes “DRUG #1” can be observed by calculating several novel continuous variables. (Existing available data allows total market share to be determined for a doctor, i.e., DRUG #1 total market share is calculated as the ratio of the total number of DRUG #1 prescriptions to the total number of prescriptions for all prescription products in the market of interest.) By using the novel categories determined above, additional market share information can be determined. For example, the New Therapy Share of DRUG #1 can be calculated as the ratio of the number of New Therapy Starts for DRUG #1 to the total number of New Therapy Starts for all prescription products in the market of interest. The Therapy Switching Share to DRUG #1 is calculated as the ratio of the number of Therapy Switches to DRUG #1 to the total number of Therapy Switches for all prescription products in the market of interest. Similarly, market share information may be calculated for Therapy Switching Share from DRUG #1, Titration Increases for DRUG #1, Titration Decreases for DRUG #1, New Concomitant Therapies, and the like.

As described above, prescription data, such as Retail Pharmacy Data 18, is often available in smaller samples tending to have erratic scatter patterns. In order to improve the predictive accuracy of the predictive model 30, the continuous variables are converted to categorical variables in the filter 28. It is noted that continuous variables are calculated in the exemplary embodiment by the prescription categorizer 24 and data calculator 26, described above. Alternatively, the continuous variables are supplied to the filter 28 from other sources input to the system 10 such as directly from the Retail Pharmacy Prescription data 18.

The filter 28 includes routines which identify all the continuous variables to be converted, and subsequently converts each continuous variable to a categorical variable, using a function, such as a cumulative percentage distribution function. The steps performed by the filter 28 are described in greater detail below.

As is known in the art, a categorical variable has a number of levels. “Levels” are defined as the number of subdivisions within a categorical variable, as is known in the art. For example, the category New Therapy Start share may have two levels, e.g. “High” and “Low.” Depending upon the distribution of the data, the categorical variable may be better represented by three levels, e.g., “High,” “Low,” and also “Medium,” and so on for four or five levels. As a first iteration towards determining the optimum number of levels, the filter 28 converts the continuous variable to a categorical variable having two such levels. The filter 28 also converts the continuous variable to a categorical variable having other levels. In accordance with the exemplary embodiment, the filter 28 converts the continuous variable to a categorical variable having three levels, a categorical variable having four levels, and a categorical variable having five levels.

The filter 28 supplies the categorical variables having each of the various levels to the predictive model 30 to determine the degree of statistical relationship of the categorical variable, e.g., New Therapy Start Share for DRUG #1, with the dependent variable, e.g., change in market share. Preferably, the predictive model 30 uses a logistic regression model or a multinomial logistic regression model, as is known in the art, to determine a p-value. The filter 28 receives the p-values calculated by the predictive model 30 for each of the various levels and analyzes the results. The filter 28 discards categorical variables not showing a minimum statistical significance, as discussed below. If the data is not discarded, the filter 28 identifies the optimal number of levels for a category that best represents the distribution of the data, based on the p-values computed above. Preferably, the optimal number of levels is determined as the respective number of levels for a categorical variable exhibiting the lowest p-value. Once the optimal number of levels is selected for each individual variable, the predictive model 30 may be run again using the optimized categorical variables to estimate the probability of the occurrence of an event relevant to the prescription therapy practices of the physician, e.g., a change in the market share of a particular prescription product, and provide an physician profile data output 32, including series of alert messages, as will be described in greater detail below.

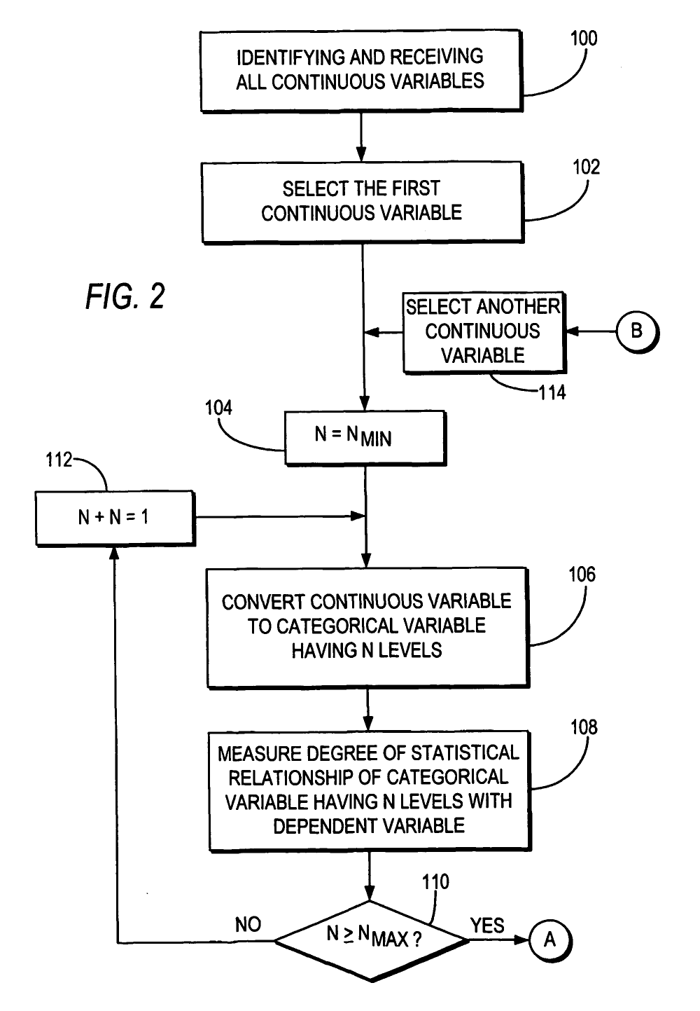

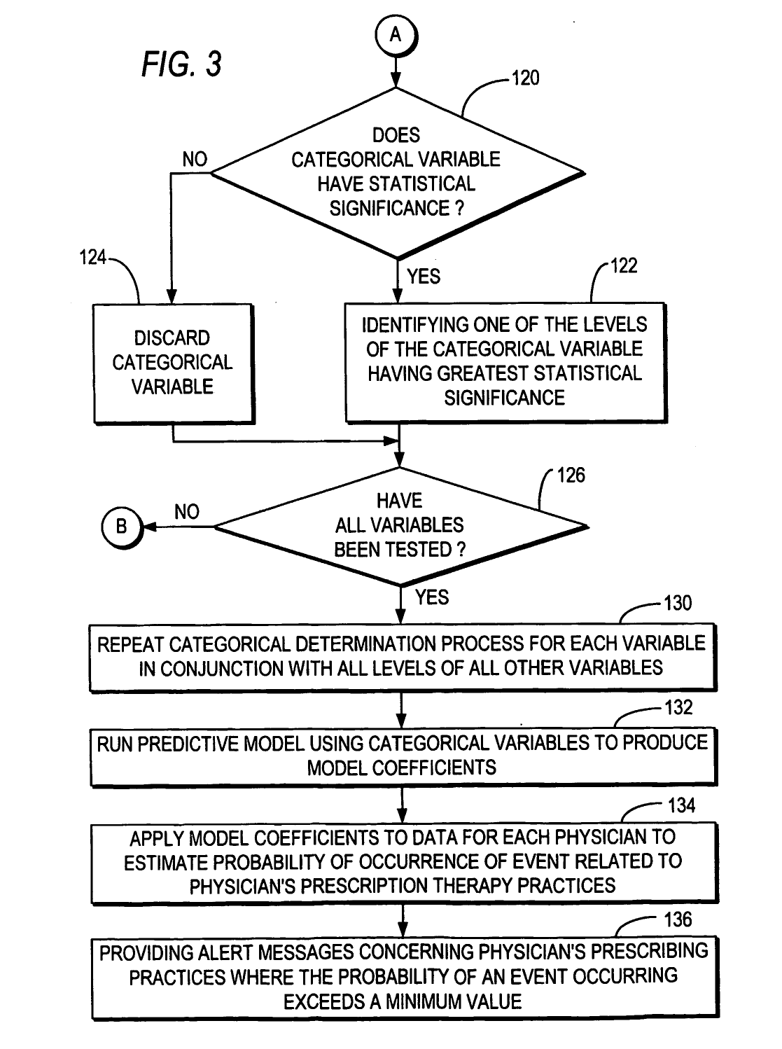

The procedures implemented by the present invention are described with respect to FIGS. 2-3. At step 100, all continuous variables available for analysis are identified and received (FIG. 2). The first continuous variable is selected for analysis at step 102. In the exemplary embodiment, the conversion of the continuous variable to a categorical variable is performed to produce a categorical variable having a first number of levels, i.e., Nₘᵢₙ. Thus, the number of levels N is initially set to Nₘᵢₙ at step 104. For example, for Nₘᵢₙ=2, there are two levels for New Therapy Start share, i.e., “Low” and “High.” The conversion step occurs at step 106. In the exemplary embodiment, a cumulative percentage distribution function is used to filter the data into a Low level of New Therapy Start share and a High level of New Therapy Start share.

TABLE 1, below, illustrates the process of step 106 of converting the continuous variable New Therapy Start share for DRUG #1 to a categorical variable having three levels, i.e., N=3. The first column lists the New Therapy Start shares for 20 different physicians. For the first physician, the New Therapy Start share for DRUG #1 is 2.48% of the New Therapy Starts for the market of interest. For the second physician, the New Therapy Start share for DRUG #1 is 5.70%, etc.

TABLE 1

| Drug #1 | | Valid | Cumulative | Categorial |
|---|---|---|---|---|
| Market Share | Frequency | Percent | Percent | Variable Level |
| 2.48 | 1 | 5.0 | 5.0 | 1.0 |
| 5.70 | 1 | 5.0 | 10.0 | 1.0 |
| 5.87 | 1 | 5.0 | 15.0 | 1.0 |
| 7.85 | 1 | 5.0 | 20.0 | 1.0 |
| 8.54 | 1 | 5.0 | 25.0 | 1.0 |
| 10.20 | 1 | 5.0 | 30.0 | 1.0 |
| 10.58 | 1 | 5.0 | 35.0 | 1.0 |
| 11.68 | 1 | 5.0 | 40.0 | 2.0 |
| 12.25 | 1 | 5.0 | 45.0 | 2.0 |
| 13.22 | 1 | 5.0 | 50.0 | 2.0 |
| 13.65 | 1 | 5.0 | 55.0 | 2.0 |
| 13.92 | 1 | 5.0 | 60.0 | 2.0 |
| 14.88 | 1 | 5.0 | 65.0 | 2.0 |
| 15.41 | 1 | 5.0 | 70.0 | 3.0 |
| 18.64 | 1 | 5.0 | 75.0 | 3.0 |
| 22.61 | 1 | 5.0 | 80.0 | 3.0 |
| 22.80 | 1 | 5.0 | 85.0 | 3.0 |
| 23.58 | 1 | 5.0 | 90.0 | 3.0 |
| 26.74 | 1 | 5.0 | 95.0 | 3.0 |
| 28.93 | 1 | 5.0 | 100.0 | 3.0 |
| Total | 20 | 100.0 | | |

In the example of TABLE 1, a cumulative percentage distribution is used to filter the market share into relatively even thirds. In this case, the first level, i.e., low market share for DRUG #1, is 2.48% through 10.58%. The second level, i.e., mid market share for DRUG #1, includes market shares greater than 10.58% through 14.88%. The third level, i.e., high market share for DRUG #1, includes all market shares greater than 14.88%. All market share values are then converted as follows: any value that falls into the first level is converted to a 1, as in the fifth column, above. Any value that falls into the second level is converted to a 2, and any value that falls into the third level is converted to a 3. For example, the value of 28.93% would be converted to a 3 because it falls into the “high” range.

At step 108, the predictive value of the categorical variable having N levels is tested at step 108. Particularly, this step is measuring the degree of statistical relationship for the categorical variable (having N levels) with the dependent variable. The predictive model 30 uses a logistic regression model or a multinomial logistic regression model, as is known in the art, to calculate the degree of statistical relationship of the categorical variable and its respective number of levels, with the dependent variable. The dependent variable in the model is the probability of an occurrence of an event relevant to the prescription therapy practices of the physician in the market of interest. Examples of such events are (1) a change, e.g., an overall loss, of percentage market share for a product, or (2) a low uptake of a new product. The dependent variable may also be categorical with most likely three or fewer levels.

Logistic regression is used to estimate the probability of an event occurring. Thus, the output of step 108 is a p-value. The probability of an event occurring can be expressed as:

Prob(event)=1/(1+e^{-z}) [1]

where e is the base of the natural logarithms and Z is a linear combination expressed as:

Z=B₀+B₁X₁+B₂X₂+. . .+BₚXₚ. [2]

An event may be, for example, a change in market share for DRUG #1 (the dependent variable). In equation [2], X is an independent, categorical variable, and B is a model coefficient. (Initially, equation [2] may include one independent variable X to compute the optimum number of levels of the categorical variable. Subsequent steps may incorporate several independent variables X, as will be described below.) The coefficients are provided by running the standard logistic regression model on statistical software such as SAS™ or SPSS™, described above, according to a method known in the art.

According to the exemplary embodiment, the range of levels is between two and five levels, i.e., Nₘᵢₙ=2 and Nₘₐₓ=5. At step 110, the conversion process is repeated if the number of levels is less than five. No more than five levels will be tested for each variable. Having more levels could compromise the predictive accuracy, because more degrees of freedom would be used in the predictive model. Degrees of freedom, as is known in the art, are the number of observations (or scores) that are free to vary. Each time a restriction limits the freedom of scores to vary, a degree of freedom is used. A level of a categorical variable would constitute such a restriction. For instance, if a variable has three levels, three degrees of freedom will be used. As the number of levels grows within and across variables, more degrees of freedom will be used. Having larger numbers of levels could compromise predictive accuracy because more degrees of freedom would be used. Consequently, a larger number of restrictions would be placed on the predictive model. By mathematical necessity, employing more levels would restrict the predictive power of the model and eventually negate the positive benefits of the categorical transformations.

If the number of levels for the categorical variable is less than five for that iteration, then the number of levels N is increased by one at step 112, and the conversion process of step 106 is repeated to create a categorical variable having N+1 levels. Steps 106 and 108 are repeated until categorical variables having 2, 3, 4 and 5 levels are calculated for the first continuous variable. If the number of levels exceeds five at step 110, the iterative process ends, and the data flow continues to step 120 (See FIG. 3). It is noted that the steps of converting continuous variables to categorical variables (step 106) and of measuring the degree of statistical relationship of the categorical variable with the dependent variable (step 108) may proceed in separate iterative loops. For example, the categorical variables for each one of the levels may be calculated first, and then the step of measuring the predictive value of the categorical variables may be subsequently performed for each one of the levels. According to yet another exemplary embodiment, categorical variables for each one of the levels may be converted simultaneously.

At step 120, the p-values of each of the levels of the categorical variable are analyzed to determine whether they are statistically significant, i.e. whether they have at least a minimum statistical significance with respect to the dependent variable. If the p-value for the variable at any number of levels is less than or equal to 0.05 as determined at step 120, the variable is considered to be statistically significant and thus having predictive value, and the process proceeds to step 122. If the p-value for the variable is not less than or equal to 0.05, that variable is discarded at step 124. A p-value of 0.05 has been used in the exemplary embodiment, although it is noted that a different p-value may be used as a threshold value for statistical significance.

At step 122, each of the probability levels, p-value, for each of the levels of the categorical variable are analyzed, and the number of levels having the lowest associated p-value is considered the optimal number of levels. For example, New Therapy Start Share for DRUG #1 with three levels, N=3, has p=0.04, and with five levels, N=5, p=0.001 as determined at step 102, above. At step 122, it is determined in the example that five levels will be used for New Therapy Start share for DRUG #1.

With continued reference to FIG. 3, step 126 determines whether all variables have been tested. If other variables are to be tested, the process proceeds to step 114 (FIG. 2), in which the next continuous variable is selected, and the categorical determination process, i.e., steps 104-124, is repeated for the each subsequent variable.

As a result of the categorical determination process for individual variables, an initial determination of the optimal number of levels is separately determined for each categorical variable. In addition, several variables that are not statistically significant, i.e., having low predictive power, are discarded. Since certain of the variables may be dependent on other variables, the process of discarding certain variables may change the predictive value of the remaining variables. Thus, step 130 is a further optimization of the categorical determination process, in which all levels of all variables are now evaluated in conjunction with each other to maximize predictive accuracy. Thus, steps 102-126 are repeated substantially identically as described above, with the following changes noted herein. For example, equation [2] above may incorporate several independent variables X, rather than one independent variable, as described above. Particularly, all permutations and combinations of levels across all variables will be tested in a sequential iterative fashion to reach maximum accuracy defined by the lowest p-value.

After the levels have been further optimized at step 130, the predictive model 30 is run at steps 132-134 to estimate the probability of the occurrence of dependent variable, i.e., an event relevant to the prescription therapy practices of a physician. The predictive model, which is a logistic regression model, is run using the levels of categorical variable obtained in steps 102-124 and refined in step 130. This process of step 132 produces a series of model coefficients such as coefficients B₀, B₁, B₂ . . . Bₚ represented in equation [2] above.

The model coefficients, as produced above, are subsequently applied to each data for each physician at step 134 to estimate a probability of occurrence of an event related to the physician's prescription therapy practices as described in equation [1] above. For example, at step 134 a particular physician may be found to have a 65% chance of trending down on a particular therapy next month, based on the data available for New Therapy Start shares and trends, Continued Therapy shares and trends, and Titration Down shares and trends, for example.

At step 136, a series of alert messages are produced based upon the probabilities generated at step 134, by reference to a table in which percentage values of the probabilities are associated with alert messages. Thus, for the above example, the physician may be found to have a 65% chance of trending down on a particular therapy. In terms of probability, 50% is considered equivalent to an event occurring by chance, above 50%, the event is more likely to occur (i.e., it is above chance) and below 50% it is less likely to occur. Continuing with the above example, 65% is 15% above the event occurring by chance, thus the value would be flagged in the database (as all values greater than 50%). An alert message communicating that a particular physician will down trend next month on a therapy is generated. Such an alert message would be conveyed to a sales representative having sales responsibility in the prescription field.

The following are additional examples of alert messages, and the events that would trigger them:

(1) “New Therapy Starts are far below the average of other doctors in this geographical region. This doctor does not start many patients on therapy,” would be triggered by a high probability that this doctor's New Therapy Starts are x % lower than average for the geographical region.

(2) “Prescriber is suddenly showing RAPID SWITCHING from DRUG #1 to DRUG #2 as of 12/01/00.” This message would be indicated by a high probability of a drop in market share due to increased Therapy Switching.

(3) “Switching from DRUG #2 to DRUG #1 is combined with decrease in new DRUG #2 starts. Doctor is most likely changing DRUG #2 to a second-line therapy.” These statements would appear under the following circumstances: high probability of a drop in market share driven by a decrease in New Therapy Starts and an increase in Therapy Switching.

One skilled in the art will appreciate that the present invention can be practiced by other than the described embodiments, which are presented here for purposes of illustration and not of limitation, and the present invention is limited only by the claims that follow.

1. A method for generating a profile concerning the prescription therapy practices of at least one physician in a therapeutic area of interest, comprising the steps of:
(a) receiving data for a continuous variable corresponding to prescriptions issued to at least one de-identified patient by at least one physician;
(b) for each number of levels of a predetermined range of levels, converting said continuous variable into a categorical variable having a respective number of levels;
(c) for each said number of levels of said predetermined range of levels, measuring the degree of statistical relationship of said categorical variable with an occurrence of an event relevant to the prescription therapy practices of the at least one physician in the therapeutic area of interest;
(d) identifying one number of levels of said predetermined range of levels of said categorical variable having the greatest statistical significance with the occurrence of the event relevant to the prescription therapy practices of the at least one physician in the therapeutic area of interest;
(e) repeating steps (a)-(d) for each one of a plurality of additional continuous variables; and
(f) estimating the probability of the occurrence of the event relevant to the prescription therapy practices of the at least one physician in the therapeutic area of interest by running a predictive model using said number of levels of said categorical variables identified in steps (a)-(e).

2. The method of claim 1, wherein the step of converting said continuous variable into said categorical variable having the respective number of levels comprises using a cumulative percentage distribution function.

3. The method of claim 1, wherein the step of converting said continuous variable into said categorical variable having the respective number of levels comprises converting said continuous variable into a categorical variable having two levels, a categorical variable having three levels, a categorical variable having four levels, and a categorical variable having five levels.

4. The method of claim 1, wherein the step of measuring the degree of statistical relationship of said categorical variable with the occurrence of the event relevant to the prescription therapy practices of the at least one physician in the therapeutic area of interest comprises running a logistic regression model, for each said number of levels of said predetermined range of levels, using said categorical variable having the respective number of levels as an independent variable.

5. The method of claim 4, wherein the step of running the logistic regression model comprises calculating, for each said number of levels of said predetermined range of levels, a p-value for said categorical variable having the respective number of levels.

6. The method of claim 4, wherein the step of measuring the degree of statistical relationship of said categorical variable with the occurrence of the event relevant to the prescription therapy practices of the at least one physician in the therapeutic area of interest further comprises discarding said categorical variable that is not statistically significant.

7. The method of claim 6, wherein the step of discarding said categorical variable that is not statistically significant comprises discarding said categorical variable having a p-value greater than 0.05.

8. The method of claim 5, wherein the step of identifying one number of levels of said predetermined range of levels of said categorical variable having the greatest statistical significance comprises determining which one number of levels of said predetermined range of levels has the lowest associated p-value.

9. The method of claim 1, further comprising generating alert messages, after step (g), indicative of the estimated probabilities calculated in step (f).

10. The method of claim 9, wherein the step of generating alert messages further comprises associating the estimated probabilities with the alert messages.

11. A system for generating a profile concerning the prescription therapy practices of at least one physician in a therapeutic area of interest, comprising:
(a) a mass storage device for storing continuous variable data corresponding to prescriptions issued to at least one de-identified patient by at least one physician;
(b) an input device, coupled to the-mass storage device, for receiving data for a plurality of continuous variables;
(c) a filter, coupled to the input device, configured to convert, for each number of levels of a predetermined range of levels, each said continuous variable into a respective categorical variable having a respective number of levels; and
(d) a statistical model, coupled to the filter, configured to receive each said categorical variable from said filter and to determine, for each said number of levels of said predetermined range of levels, the degree of statistical relationship of each said categorical variable with the occurrence of an event relevant to the prescription therapy practices of the at least one physician in the therapeutic area of interest,
said filter configured to supply each said categorical variable to the statistical model, to receive said degree of statistical relationship of each said categorical variable data with the occurrence of the event as determined by the statistical model for each said number of levels of said predetermined range of levels, and to identify one of said number of levels of each said categorical variable having the greatest statistically significant relationship with the occurrence of the event,
said statistical model configured to determine, for each said number of levels of said predetermined range of levels, the degree of statistical relationship of each said categorical variable in conjunction with all said categorical variables with the occurrence of the event,
said filter configured to identify one of said number of levels of each said categorical variable in conjunction with all said categorical variables having the greatest statistically significant relationship with the occurrence of the event, and
said statistical model further configured to estimate the probability of the occurrence of the event by using all said categorical variables having the respective number of levels identified by the filter.

12. The system of claim 11, wherein the filter is configured to convert, for each number of levels in the said predetermined range of levels, said continuous variable into said categorical variable using a cumulative percentage distribution function.

13. The system of claim 12, wherein said number of levels in said predetermined range of levels of the categorical variable consists of two levels, three levels, four levels, and five levels.

14. The system of claim 11, wherein the statistical model is configured to run, for each number of levels in the said predetermined range of levels, a logistic regression model using said categorical variable data having the respective number of levels as an independent variable.

15. The system of claim 14, wherein the statistical model is configured to calculate, for each number of levels in the said predetermined range of levels, a p-value of said categorical variable data having the respective number of levels.

16. The system of claim 15, wherein the filter is further configured to discard a categorical variable that is not statistically significant.

17. The system of claim 16, wherein the filter is configured to discard a categorical variable having a p-value greater than 0.05.

18. The system of claim 15, wherein the filter is configured to identify the number of levels of the categorical variable having the greatest statistical significance by determining the number of levels of the categorical variable having the lowest associated p-value.

19. The system defined in claim 11, wherein the filter is configured to provide alert messages associated with the probability of the occurrence of the event relevant to the prescription therapy practices of the at least one physician in the therapeutic area of interest.
